(19) United States
(12) Patent Application Publication
(10) Pub. No.: US 2025/0251267 A1
(43) Pub. Date: Aug. 7, 2025

(54) FLOW METER WITH INTEGRATED AUTOMATIC SHUT-OFF VALVE AND REMOTE READ ACCESS

(71) Applicant: Metropolitan Industries, Inc., Romeoville, IL (US)

(72) Inventor: James Andrew Nimmer, Minooka, IL (US)

(21) Appl. No.: 19/045,296

(22) Filed: Feb. 4, 2025

Related U.S. Application Data
(60) Provisional application No. 63/549,616, filed on Feb. 5, 2024.

(51) Int. Cl. G01F 15/00; G01F 1/05

(52) U.S. Cl. CPC G01F 15/005; G01F 1/05

(57) ABSTRACT

A flow meter has an integrated automatic shut-off valve and remote read access. The meter includes a body having an inlet and an outlet and a rotating element positioned in the body that rotates in response to a fluid flow through the flow meter body. A shut-off valve is disposed on the valve body at the inlet. The flow meter can include a flow monitoring sensor including a head unit mounted on the flow meter. The flow monitoring sensor includes a body, a control panel, and circuitry. The flow monitoring sensor includes a Hall effect sensor including a magnet and at least one sensor. The magnet is disposed on the rotating element and the sensor is located in the head unit.

### CROSS REFERENCE TO RELATED APPLICATIONS

The present application claims priority to and the benefit of U.S. Provisional Patent Application No. 63/549,616 filed on Feb. 5, 2024 titled “Flow Meter with Integrated Automatic Shut-Off Valve and Remote Read Access.” Which is hereby incorporated by reference in its entirety.

### BACKGROUND

The following description relates to flow meters and more particularly to flow meters for a fluid, the flow meter having an integrated automatic shut-off valve and remote read access.

Flow meters are used to measure and may totalize the flow of a fluid. For example, flow meters are often found in residential and commercial facilities to measure and totalize the flow of water for billing, monitoring, and other purposes. One example of a known water flow meter is illustrated in FIG. 1.

The performance and accuracy of water flow meters or totalizers for residential and commercial facilities degrade over time and as such the meters require periodic replacement. Many such flow meters are installed within a specific and defined space or footprint. This is done so that the meters can be removed and replaced without the need to rework, e.g., cut/modify the inlet and/or outlet piping or modify or relocate other equipment. There are instances in which various adapters or pipe stubs may be used to properly locate and install such meters within the defined space. One example of a known adapter is illustrated in FIG. 3.

In order to isolate flow meters from a supply (for example from a water main line), shut-off valves can be positioned between the main supply and the meter. An example of a known shut-off valve is shown in FIG. 2. Isolation may be used to shut off service to a residence or facility to, for example, perform maintenance in the residence or facility, or to isolate flow if the residence or facility is vacant. Known shut-off valves are manually operated components, are separate from the associated flow meter, and are typically located and mounted adjacent to the flow meter.

Flow meters also require “reading” for billing and other purposes. Newer replacement flow meters permit remote access or reading the flow/volume of water measured by the meter. Remote access is provided by short range wireless communication. And while such remote access or reading has greatly increased efficiency in monitoring and recording usage, the meter technology has not appreciably changed. Further, it may be desirable for the water supply provider to replace existing meters with meters that are capable of long-range monitoring or that are internet enabled. However, this involves replacing the meter body that is attached to the water supply piping of a building which includes the flow monitoring head unit.

Known flow meter technology is mechanical and may use an oscillating piston, a nutating disk or a vaned wheel (much like a fan) that, in each case, moves or rotates within the body of the meter, which rotation translates to a mechanical odometer-like member or dial that totalizes the flow through the meter. While such configurations work well, because they are mechanical, they may wear over time resulting in errors in readings.

Accordingly, there is a need for a flow meter that incorporates an integrated shut-off valve. Desirably, such a shut-off valve can be remotely operated. More desirably, such a flow meter can be installed within the defined space confines (e.g., footprint) of known flow meters. More desirably still, such a flow meter accommodates an electronic flow sensor that permits remote long range and short range reading of the flow meter.

### SUMMARY

An improved flow meter has an integrated shut-off valve and remote read access. The flow meter includes a body having an inlet and an outlet. A rotating element is positioned in the body that rotates in response to a fluid flow through the flow meter. A shut-off valve is disposed on the valve body at the inlet. In embodiments, the shut-off valve is integrated into the flow meter body. The shut-off valve can be directly mounted onto the flow meter body.

The shut-off valve includes an actuator, and the actuator is one or both of locally operated and remotely operated. In embodiments, the valve is a quarter turn valve.

The flow meter can further include a flow monitoring sensor. The flow monitoring sensor includes a head unit having a body, a control panel, and circuitry. The head unit is mounted on the flow meter.

The flow monitoring sensor is a Hall effect sensor including a magnet and at least one sensor. The magnet is disposed on the rotating element and the sensor is located in the head unit. In embodiments, the magnet is a ring magnet, and the at least one sensor is two sensors. The two sensors are positioned in the head unit and can be equally radially spaced from a projection of an axis that extends upwardly from the rotating element and are circumferentially spaced from one another.

The foregoing general description and the following detailed description are examples only and are not restrictive of the present disclosure. Other aspects and advantages will become more apparent from the following detailed description when taken in conjunction with the accompanying drawings.

### DESCRIPTION OF THE DRAWINGS

The benefits and advantages of the present embodiments will become more readily apparent to those of ordinary skill in the relevant art after reviewing the following detailed description and accompanying drawings, wherein:

FIGS. 1-3 are perspective views of a known flow meter (FIG. 1), a known shut-off valve (FIG. 2), and a known adapter fitting (FIG. 3);

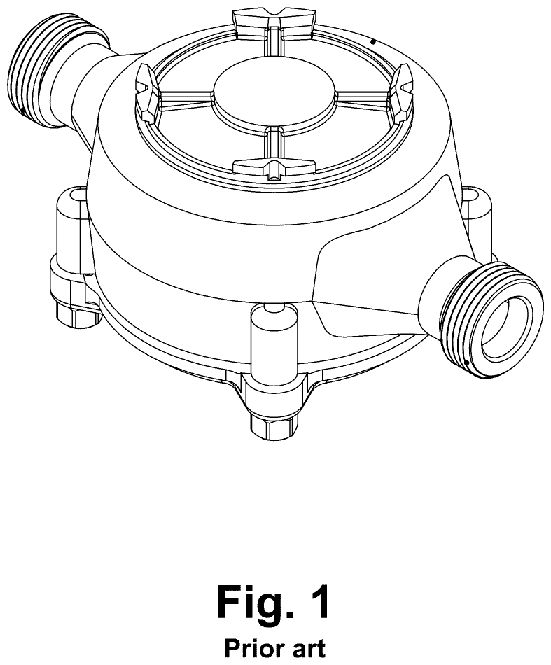

FIG. 4 is a perspective view of an embodiment of a flow meter with integrated automatic shut-off according to the present disclosure;

FIG. 5 is a top view of the flow meter;

FIG. 6 is a cross-sectional view taken along line 3-3 of FIG. 2;

FIG. 7 is a top view of an embodiment of a flow monitoring sensor for use with a flow meter;

FIG. 8 is a side view of the sensor of FIG. 7;

FIG. 9 is a view of the internals of the sensor as seen from the bottom of the sensor;

FIG. 10 is a top view of the sensor as mounted to the flow meter; and

FIG. 11 is a front view of a series of flow meters, some of which have flow monitoring sensors mounted thereto.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

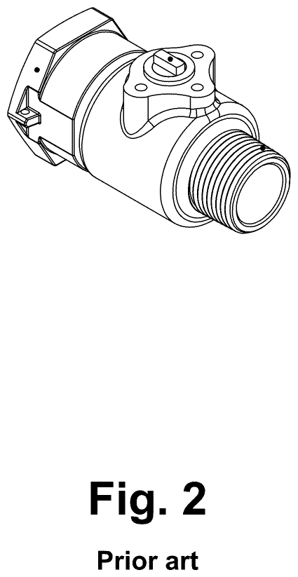

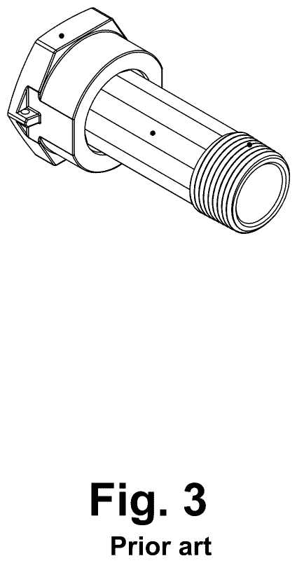

Referring now to the figures, and in particular to FIGS. 4-6, there is shown an embodiment of a flow meter 10 having an integrated automatic shut-off valve 12. The flow meter 10 includes a body 14 having inlet 16 and outlet 18 coupling connections, and the shut-off valve 12 integrated into the flow meter body 14. In embodiments, the shut-off valve 12 can be integrated into the meter body 14 by mounting the valve 12 directly to the body 14. The valve 12 can be mounted to the body 14 by, for example, bolts 20 that extend through the valve 12 and into mating threaded bores (not shown) in the flow meter body 14.

The flow meter 10 includes a bottom cover 22 that is removable from the meter body 14. The bottom cover 22 can be bolted to the body 14, or mounted to the body 14 by other means which will be recognized by those skilled in the art. The bottom cover 22 provides access to the internal components of the flow meter 10. A present flow meter 10, as illustrated in FIGS. 4-6 is a positive displacement nutating disk 24 flow meter 10. The flow meter 10 has a length L10 configured to be installed within the defined space confines (e.g., footprint) of known flow meters.

The shut-off valve 12 is, as noted above, mounted to the flow meter body 14. As illustrated the shut-off valve 12 is directly mounted to the body 14 by bolts 20. The valve 12 includes an inlet 26 and an outlet 28, and a valve plug chamber 30 between the inlet 26 and the outlet 28. Alternatively, the shut-off valve 12 can be incorporated into a stub pipe fitting mounted to the flow meter 10.

A valve plug 32 is poisoned in the plug chamber 30. The plug 32 includes a stem 34 that extends upwardly out of the valve 12. One suitable type of valve is a quarter-turn (i.e., 90° rotating) valve. Seals 36 are poisoned on the stem 34 to prevent leakage around the stem 34. In an embodiment, a pair of seals 36 are positioned on the stem 34. Alternately, valve packing may be used to prevent leakage around the stem 34.

In embodiments, an actuator (not shown) can be mounted to the valve 12 and operably mounted to the valve stem 34. In embodiments, the actuator can be remotely operated by an electronic signal, via a hardwired connection, or wirelessly via long range and/or short range wireless connection, such as Bluetooth, LAN, WAN, Wi-Fi, etc. Power to actuate the actuator can be provided locally. Such an arrangement permits water supply providers or owners or residents of buildings to interrupt the inflow of water to the facility, such as a building, by remote actuation of the shut-off valve 12.

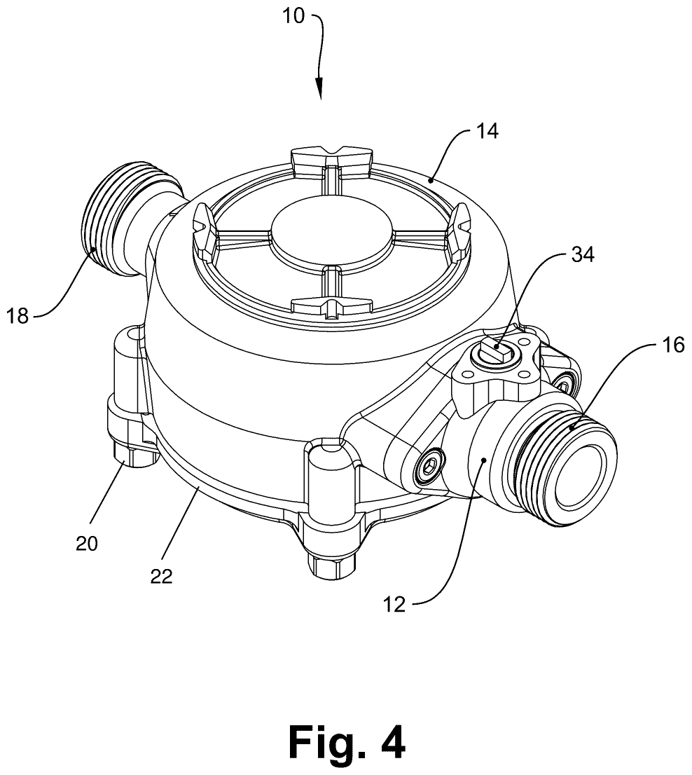

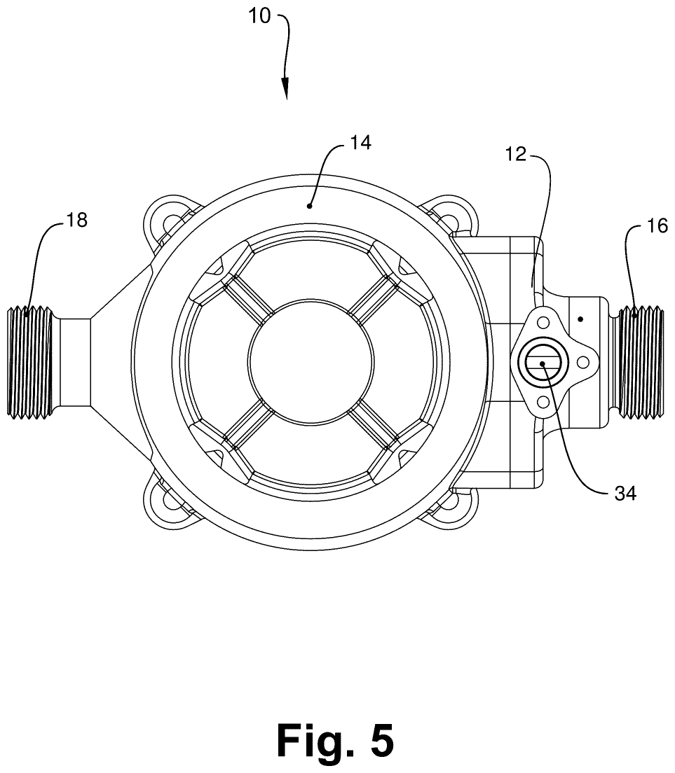

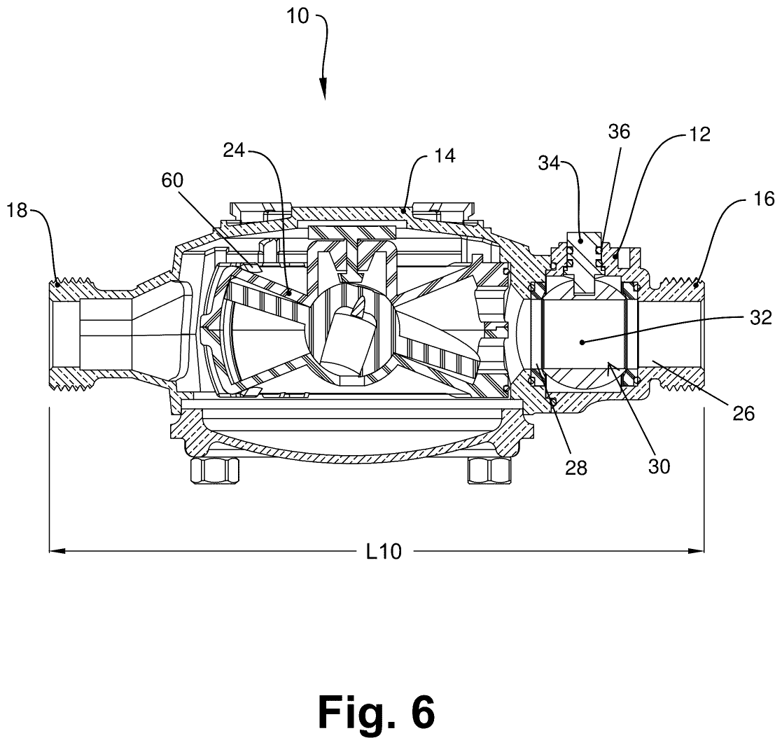

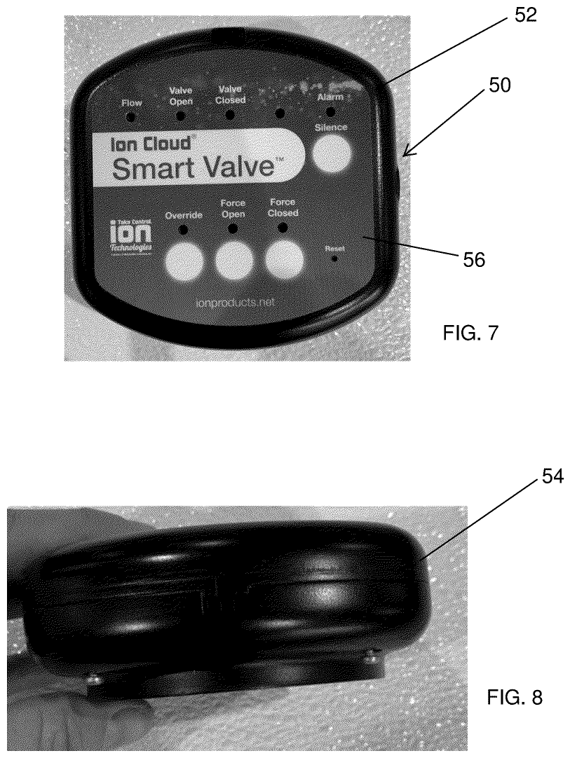

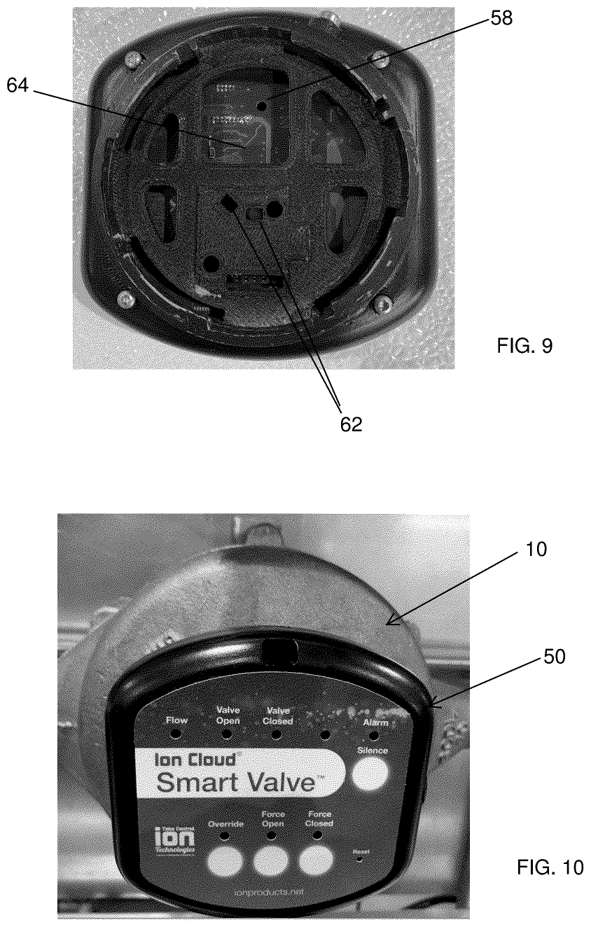

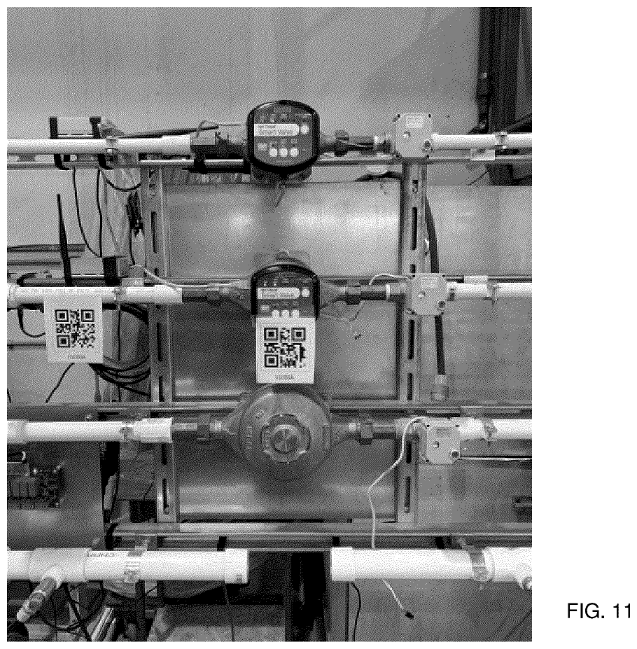

Turning now to FIGS. 7-11 there is shown a flow monitoring sensor 50 configured for use with the flow meter 10. The sensor 50 includes a head unit 52 having a body 54, a control panel 56, and circuitry 58 (as seen on the integrated circuit board internal to the sensor body 54). The sensor 50 uses a Hall effect sensor to sense the flow of fluid through the meter 10. Such a sensor requires a magnet 60 and one or more Hall sensors 62 that sense the magnetic field strength at the sensor(s) 62. In a present embodiment, referring briefly again to FIG. 6, a ring magnet 60 is positioned on and moves with the flow meter nutating element/disk 24.

The ring magnet 60 cooperates with Hall sensors 62 positioned in the sensor body 54. In a present embodiment there are two Hall sensors 62a,b positioned in the sensor body 54 that cooperate with the ring magnet 60. The Hall sensors 62a,b are stationary in the sensor body 54 and are equally radially spaced from a projection of an axis A that extends upwardly from the nutating disk 24 and are circumferentially spaced from one another. Electrical signals from the Hall sensors 62a,b are sent to a processor 64, such as a processor within the head unit 52, to calculate the volume and/or flow rate through the flow meter 10.

In such a configuration, there is no mechanical connection between the moving parts of the flow meter 10 (e.g., the nutating disk 24) and the flow monitoring sensor 50. That is, the Hall sensors 62a,b function to sense the magnetic field strength through the flow meter body 14. Such an arrangement has the advantage of not requiring an opening in the flow meter body for connection to the flow monitoring sensor.

Additionally, such a flow monitoring sensor 50 can be designed and configured to match the mechanical interface of existing flow meter bodes, to further facilitate the use of such a sensor wirelessly via long range and/or short range wireless connection, such as Bluetooth, LAN, WAN, Wi-Fi, etc. That is, the flow monitoring sensor head 52 can replace an existing analog head on a meter to provide remote reading.

It is further contemplated that power can be provided to the flow monitoring sensor 50 locally, such as a hard wired electrical connection, or battery powered, such as by rechargeable battery power. For example, the flow monitoring sensor 50 can include a low power cell module with a high capacity/long service life lithium battery.

Advantageously, the present flow meter 10 having integrated automatic shut-off and remote read access incorporates an integrated shut-off valve 12 and can be installed within the defined space confines (e.g., footprint) of known flow meters to permit readily retrofitting existing systems. Such a shut-off valve 12 can be remotely operated to permit water supply providers or owners or residents of buildings to interrupt the inflow of water to the facility, such as a building, by remote actuation of the shut off-valve 12. Further, such a flow meter 10 accommodates an electronic flow monitoring sensor 50 to permit remote long range and short range reading of the flow rate and/or volume, which flow monitoring sensor can be retrofit onto many existing flow meters.

All patents referred to herein, are hereby incorporated herein in their entirety, by reference, whether or not specifically indicated as such within the text of this disclosure. In addition, it is understood that terminology referring to directions or relative orientations, such as, but not limited to, “forward” “rearward” “inner” “outer” “upper” “lower” “raised” “lowered” “top” “bottom” “above” “below” “alongside” “left” and “right” are used for purposes of example and do not limit the scope of the subject matter described herein to such orientations or relative positioning.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A flow meter, comprising:
a body, the body having an inlet and an outlet;
a rotating element positioned in the body that rotates in response to a fluid flow through the flow meter body; and
a shut-off valve disposed on the valve body at the inlet.

2. The flow meter of claim 1, wherein the shut-off valve is integrated into the flow meter body.

3. The flow meter of claim 1, wherein the shut-off valve is directly mounted onto the flow meter body.

4. The flow meter of claim 1, wherein the shut-off valve includes an actuator.

5. The flow meter of claim 4, wherein the actuator is one or both of locally operated and remotely operated.

6. The flow meter of claim 1, wherein the shut-off valve is a quarter turn valve.

7. The flow meter of claim 1, further including a flow monitoring sensor.

8. The flow meter of claim 7, wherein the flow monitoring sensor includes a head unit having a body, a control panel, and circuitry, the head unit mounted on the flow meter.

9. The flow meter of claim 8, further including a Hall effect sensor including a magnet and at least one sensor, wherein the magnet is disposed on the rotating element and wherein the sensor is located in the head unit.

10. The flow meter of claim 9, wherein the magnet is a ring magnet.

11. The flow meter of claim 10, wherein the at least one sensor is two sensors.

12. The flow meter of claim 11, wherein the two sensors are positioned in the head unit equally radially spaced from a projection of an axis that extends upwardly from the rotating element and wherein the two sensors are circumferentially spaced from one another.
